(19) United States
(12) Patent Application Publication
(10) Pub. No.: US 2016/0082875 A1
(43) Pub. Date: Mar. 24, 2016

(54) Adjustable Bulkhead for Dividing a Cargo Container into Multiple Compartments

(71) Applicant: B2B Casuals, Inc., Quinlan, TX (US)

(72) Inventor: Jerrell P. Squyres, Point, TX (US)

(73) Assignee: B2B CASUALS, INC., Quinlan, TX (US)

(21) Appl. No.: 14/495,597

(22) Filed: Sep. 24, 2014

(51) Int. Cl. B60P 7/14; B61D 45/00; B60P 7/15

(52) U.S. Cl. CPC B60P 7/14; B60P 7/15; B61D 45/006

(57) ABSTRACT

A bulkhead for dividing a cargo container into multiple compartments. In one embodiment the bulkhead includes two panels that span the width and height of the cargo container when adjacent to each other. Each panel has one or more angle brackets mounted to it. Each angle bracket is bent approximately 90°, forming a base section and a flanged arm. The base section is mounted to the back face of the panel, and the flanged arm inserts through a slot in the panel and projects in front of the panel. Cross bars slide through openings in the angle brackets in front of the panels and couple the bulkhead to tracks along the walls of the container. The cross bars can be coupled to multiple points along these tracks, allowing the position of the bulkhead to be adjusted along the length of the container.

### TECHNICAL FIELD

The present invention relates generally to the field of cargo containers and more specifically to an adjustable bulkhead that can be used to divide a cargo container into two or more separate compartments.

### BACKGROUND OF THE INVENTION

Cargo containers, such as those used in shipping, on railcars, and pulled by tractor trailers have sufficient volume to hold large quantities of cargo. However, this generous capacity is often greater than that required by individual clients. Consequently, a single cargo container can be used to ship goods for multiple clients at once. Such consolidation allows both the carrier and clients to benefit from economies of scale.

However, for a variety of reasons, the carrier and clients may wish to avoid the co-mingling of goods. For example, co-mingling increases the risk of errors and delays at the point of delivery as goods have to be sorted and separated. Furthermore, separating cargo into discrete, measurable compartments allows carriers to more accurately apportion pro rata fees to clients.

FIG. 1 is a perspective view of a cargo container and adjustable bulkhead in accordance with the prior art. FIG. 2 is a partially exploded perspective view of the bulkhead assembly in accordance with the prior art. This bulkhead design is disclosed in U.S. Pat. No. 7,731,462. The bulkhead 100 comprises two sections 101, 102 made of ⅝-inch plywood. When the sections 101, 102 are positioned next to each other the bulkhead extends from the first wall 121 of the container across to the second wall (not shown) and from the container top 122 to the container bottom 123. When installed, the bulkhead divides the container into a first compartment 111 and a second compartment 112.

The bulkhead is mounted inside the container by means of two cross bars 130 that extend across the width of the container. These cross bars insert into either a horizontal track 140 or a vertical track 141 along the walls of the container, allowing the position of the bulkhead to be adjusted along the length of the container. The cross bars are coupled to the bulkhead by means of angle brackets 150.

The cross bars are further comprised of two bars 131, 132 that, when combined, span the width of the container. These two bars are joined together by a collar 135 that is integral with one of the bars. The other bar is then slidably disposed into the collar and locked in place with a spring clip 136 to join the bars 131, 132 together to form the cross bar 130.

Unfortunately, the bulkhead in this prior art design is vulnerable to several structural weaknesses that could result in the bulkhead becoming damaged or dismounted during transportation, resulting in comingling of cargo or even damage to cargo.

As can be seen clearly in FIGS. 1 and 2, the cross bars 130 and the angle brackets 150 are mounted on only one side of the bulkhead. In fact, the '462 patent places particular emphasis this feature. The use of angle brackets with elliptical openings permits the cross bar to have some play of movement in a plane parallel to the face of the bulkhead. This partially reduces mechanical stress at the point of mounting. However, by placing both the cross bars and the mounting brackets on the same side of the bulkhead, the attachment points of the brackets are vulnerable to torque applied perpendicularly to the bulkhead. If sufficient perpendicular force is applied against the bulkhead, e.g., from shifting cargo or rough driving conditions, there is the potential of the brackets being torn away from bulkhead, as illustrated in FIG. 3.

Another mechanical weakness of the prior art bulkhead assembly is the use of a collar and pin to join the two halves of the cross bars. Due to the presence of the collar 135 the subcomponent bars 131, 132, do not directly mate with each other but rather lay end to end inside the collar. The only mechanical link securing the bars 131, 132 together is the spring clip 136 inserted into the collar. Needless to say, the potential forces exerted against that pin could be substantial under rough transportation conditions, resulting in a mechanical failure of the pin and separation of the bars 131, 132. Such separation would effectively uncouple the two halves 101, 102 of the bulkhead.

Therefore, it would be desirable to have a bulkhead assembly for cargo containers that overcomes the mechanical weaknesses of the prior art and provides sufficiently robust support under rough transportation conditions.

### SUMMARY OF THE INVENTION

The present invention provides a bulkhead assembly for dividing a cargo container into multiple compartments. In one embodiment of the present invention the bulkhead includes two panels that span the width and height of the cargo container when placed adjacent to each other. Each panel has one or more angle brackets mounted to it. Each angle bracket is bent at an approximately 90° angle, forming a base section and a perpendicular flanged arm. The base section is mounted to the back face of the panel, and the flanged arm inserts through a slot in the panel and projects from the front face of the panel. A backing plate can also be mounted on the front face of the panel and coupled to the base section of the bracket via carriage bolts and nuts.

In one embodiment of the invention two cross bars at different heights are slid through openings in the flanged arms of the angle brackets. These cross bars span the width of the container and couple the bulkhead to tracks mounted on the walls of the container, thereby securing the bulkhead in place. The cross bars can be coupled to multiple points along these tracks, allowing the position of the bulkhead to be adjusted along the length of the container.

In one embodiment of the present invention, the cross bar is further comprises of two sections of tubing, wherein one section is partially slidably disposed into the other. They are held together from contact friction, which can be increased by means of a tack weld on one of the tubing sections.

### BRIEF DESCRIPTION OF THE DRAWINGS

The novel features believed characteristic of the invention are set forth in the appended claims. The invention itself, however, as well as a preferred mode of use, further objects and advantages thereof, will best be understood by reference to the following detailed description of an illustrative embodiment when read in conjunction with the accompanying drawings, wherein:

FIG. 1 is a perspective view of a cargo container and adjustable bulkhead in accordance with the prior art;

FIG. 2 is a partially exploded perspective view of the bulkhead assembly in accordance with the prior art;

FIG. 3 is a top, cross-sectional view of a bulkhead assembly in accordance with the prior art, which illustrates the potential for separation of angle brackets from the bulkhead;

FIG. 4 is a top, cross-sectional view of a bulkhead assembly depicted in accordance with the present invention;

FIG. 5 is a top, cross-sectional view of an alternate embodiment of the present invention that includes the addition of a reinforcing plate for the bracket;

FIG. 6 is a cross-sectional view of the cross bar coupling depicted in accordance with the present invention;

FIG. 7 is a front view of the bulkhead assembly in accordance with the present invention;

FIG. 8 is a rear view of the bulkhead assembly in accordance with the present invention;

FIG. 9 shows a front view of an assembled bulkhead in accordance with the present invention;

FIG. 10 shows a close view of a rack gear, paddle handle and locking mechanism in accordance with the present invention; and

FIG. 11 shows an installed bulkhead in accordance with the present invention.

### DETAILED DESCRIPTION OF THE DRAWINGS

Referring to FIG. 4, a top, cross-sectional view of a bulkhead assembly is depicted in accordance with the present invention. It should be emphasized from the outset that FIG. 4 is not drawn to scale, and the relative size and thickness of the components of the bulkhead assembly are unlikely to match those depicted. The scale used in FIG. 4 is merely for ease of illustration and understanding the functional interrelationship of the components.

The bulkhead assembly 200 includes the bulkhead proper, comprised of two panels 221, 222 that span the width and height of the cargo container. The specific material and thickness used for the bulkhead panels can vary depending on the needs of the user, but for many applications standard ⅝-inch plywood will suffice. Conceivably, the bulkhead of the present invention could comprise a single panel in the case of small cargo containers. The present example assumes application to a larger container such as that used with a tractor trailer, which would make a single panel unwieldy for day to day operations.

These bulkhead panels 221, 222 are anchored to the walls of the container by means of a cross bar comprising at least two sub-bars 231, 232 that span the width of the container when connected. The bars 231, 232 can be made from steel tubing, cast aluminum housing, or other materials possessing suitable strength-to-weight properties.

The cross bars 231, 232 are coupled to the bulkhead by means of angle brackets 210 made from, e.g., 3/16-inch mild steel or other suitable material. The angle brackets 210 are bent at an approximately 90° angle, thereby forming a base section 211 and a flanged arm 212. The base section 211 of the angle bracket is placed on the back side of the bulkhead as shown (see also FIG. 8) and secured in place by means of one or more carriage bolts 213 that pass through the bulkhead and base section from the front and are secured by a nut 214 on the back. The type of bolt and nut used will depend on the needs of the user and the specific materials chosen for the assembly components, but ⅜-inch nyloc bolts and nuts are suitable for most applications.

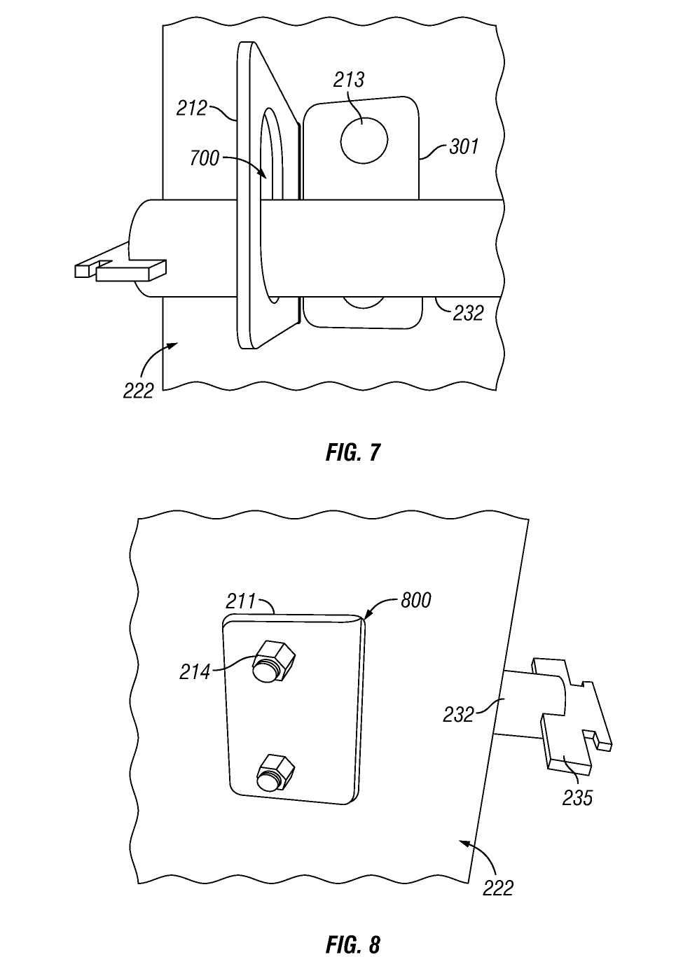

The flanged arm 212 of each bracket passes through a slot in the bulkhead to project in front of the bulkhead as shown. The cross bars 231, 232 are then fed through openings in the flanged arm (shown more clearly in FIG. 7).

In the present example, four such angle brackets are used across the width of the bulkhead, two on each panel. Less or more brackets may be used depending on the width of the bulkhead and container in question.

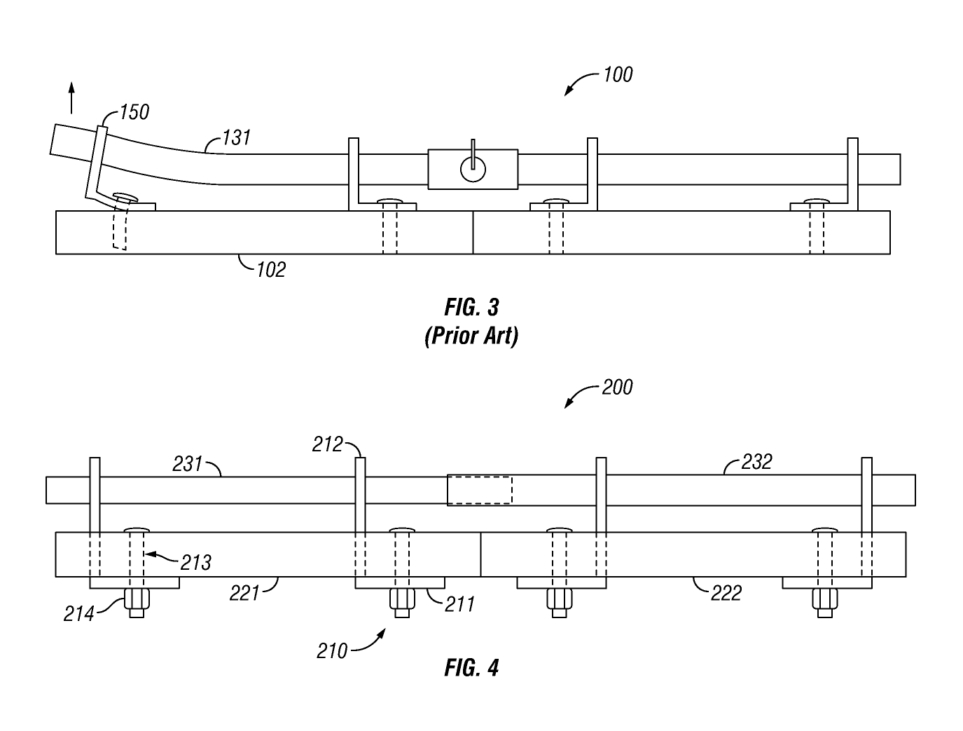

The configuration of the present invention provides considerably greater structural stability than prior art designs. If the cross bar bows under strain and exerts perpendicular force away from the bulkhead (such as shown in FIG. 3), this force would act to pull the base section 211 of the angle bracket 210 against the bulkhead rather than away from it.

Conversely, if the cross bar exerts perpendicular force toward the bulkhead there is potential for the base section 211 to be pushed away from the bulkhead. However, such movement is limited by the presence of the cross bars 231, 232 on the opposite side of the bulkhead. By sandwiching the bulkhead panels 221, 222 between the bracket base section 211 and the cross bars 231, 232, the present invention ensures that the cross bar cannot be separated from the bulkhead.

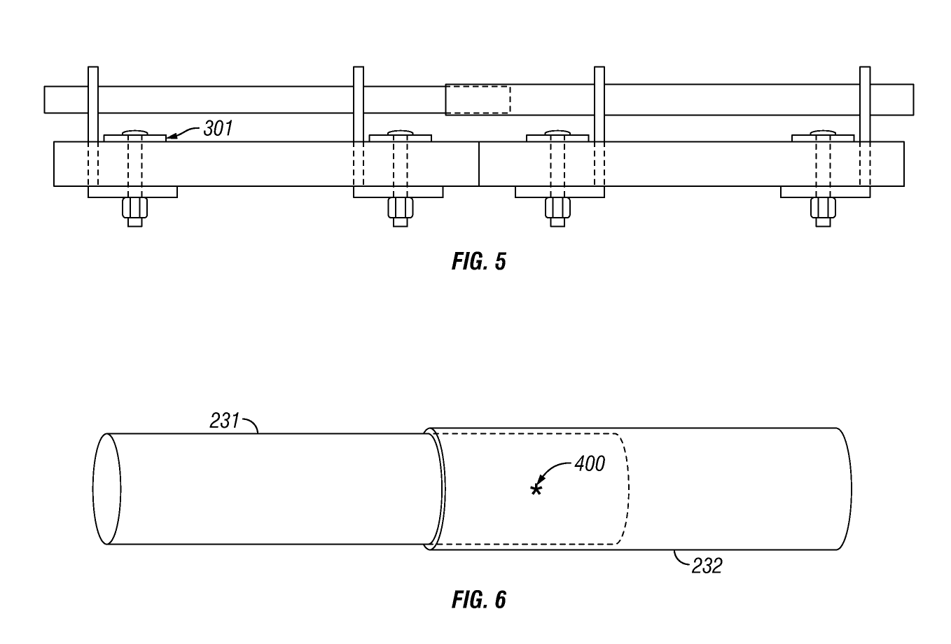

FIG. 5 shows an alternate embodiment of the present invention. This embodiment is virtually identical to that shown in FIG. 4 but has the additional feature of a backing plate 301 on the front side of the bulkhead. This reinforcing plate provides additional structural support to the bracket assembly. The desirability for this additional plate will depend on several factors such as the strength and thickness of the bulkhead panels, the length and thickness of the carriage bolts, etc.

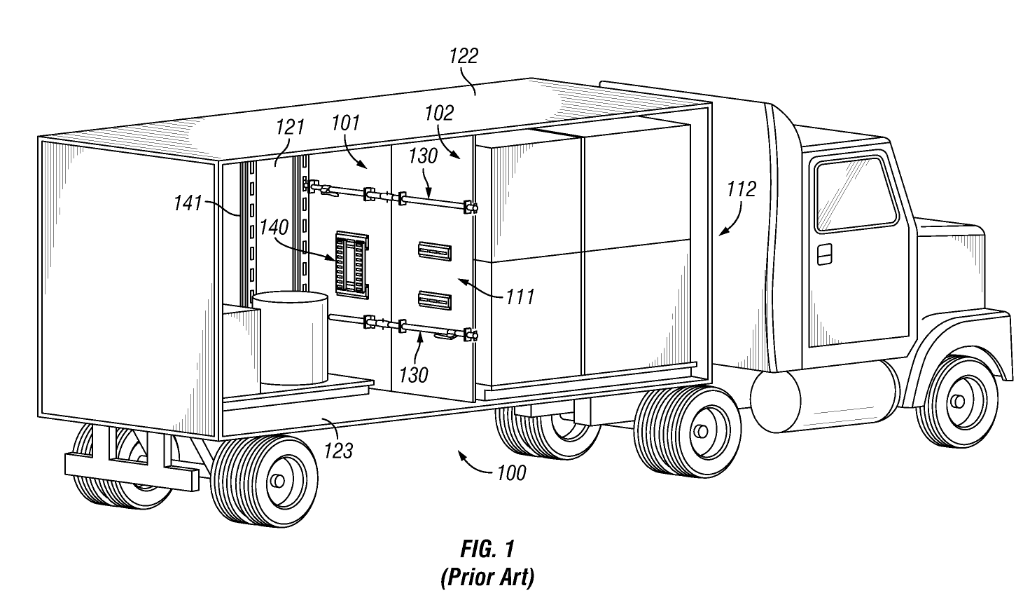

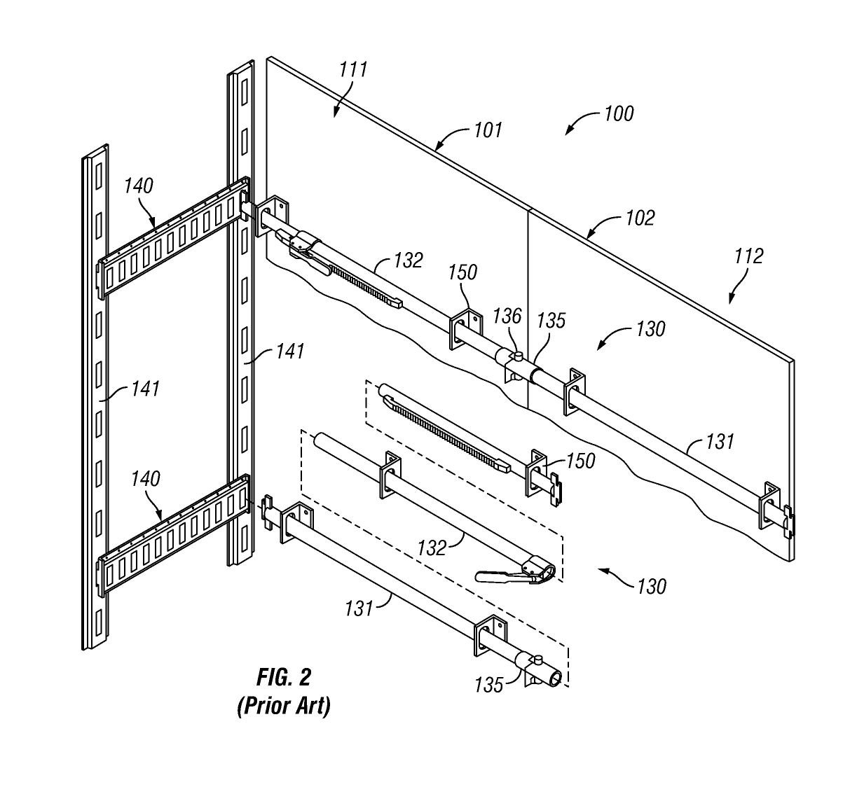

FIG. 6 is a cross-sectional view of the cross bar coupling depicted in accordance with the present invention. FIG. 6 is a closer view of the cross bar coupling depicted in FIGS. 4 and 5. As shown in FIGS. 1 and 2, the prior art uses a collar to couple the cross bars end to end, held in place with a spring clip. In contrast, in the present invention bars 231 and 232 comprise tubes that are of slightly different diameter. For purposes of the present example, tube 232 has a larger diameter than tube 231, allowing tube 231 to be slidably disposed inside tube 232 to join them together. By fitting one tube directly into the other, this configuration avoids the mechanical weakness of relying on a spring clip to keep them together, particularly under conditions of torque and bowing during rough transport conditions.

The tightness of the fit between the tubes 231, 232 is provided by a small differential between their diameters. The tightness of the fit is further reinforced by means of a tack weld 400 on one of the tubes.

FIG. 7 is a front view of the bulkhead assembly in accordance with the present invention. This is a close view of one of the angle brackets. The slight perspective in this view shows an elliptical opening 700 in the flanged arm 212 of the bracket through which the cross bar 232 inserts. The elliptical opening 700 in this embodiment allows some vertical play in the cross bars 232 to minimize mechanical stress on the bracket. This particular example also includes the backing panel 301 mounted to the front of the bulkhead.

FIG. 8 is a rear view of the bulkhead assembly in accordance with the present invention. This figure shows the base section 211 of the bracket mounted on the back of the bulkhead panel 222. From this perspective one can more clearly see the slot 800 through which the flanged arm of the angle bracket feeds through to the front of the bulkhead. One can see how the bulkhead panel 222 is sandwiched between the angle bracket base section 211 on the back and the cross bar 232 on the front.

FIG. 8 also shows an end plug 235 at the end of the cross bar 232, which is used to mount the cross bars to the sides of the container. It should be emphasized that the end plug 235 is merely one example of how the bulkhead can be mounted. Other mounting means can be employed within the scope of the present invention.

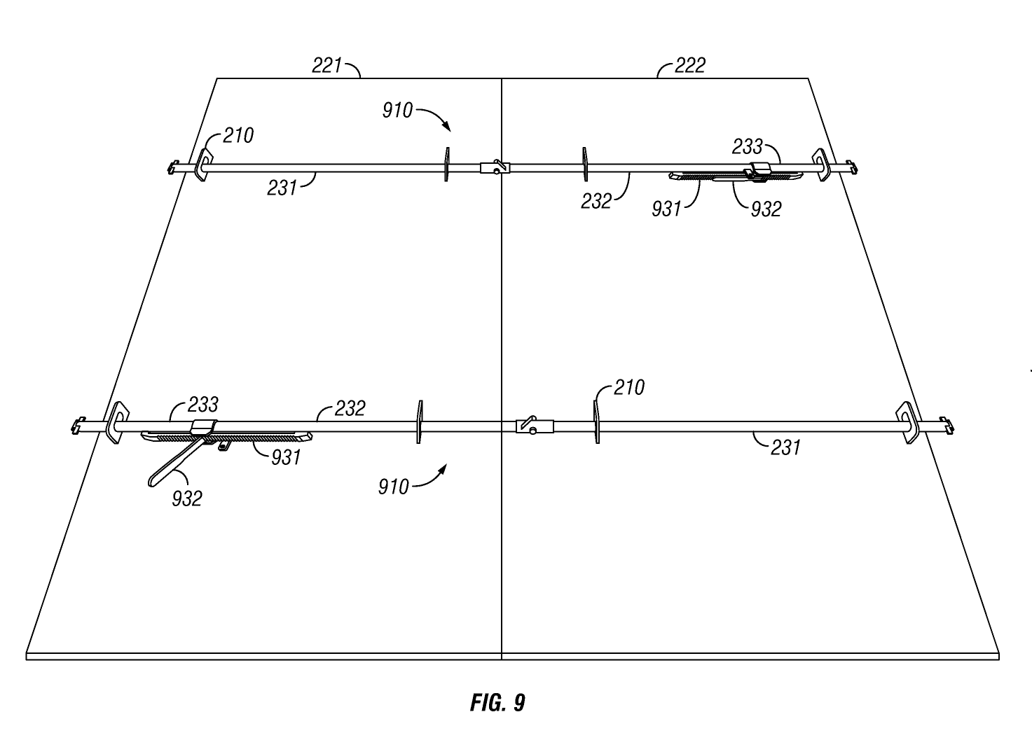

FIG. 9 shows a front view of an assembled bulkhead in accordance with the present invention. This example uses two cross bars 910 for support, but more or less cross bars can be used depending on the size of the bulkhead and container. In this particular example, each cross bar 910 further comprises three sub-bars 231, 232, 233 and a rack gear 931 and paddle handle 932 for adjusting the length of the cross bars.

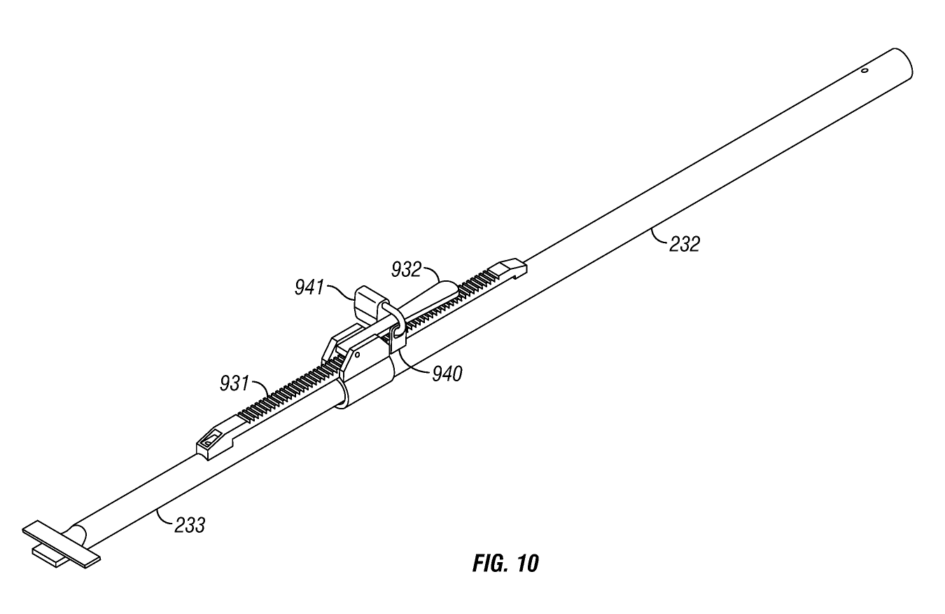

FIG. 10 shows a close view of a rack gear, paddle handle and locking mechanism in accordance with the present invention. In this embodiment, an adjustable bar 233 is slidably disposed in bar 232. The rack gear 931 and paddle handle 932 are used to adjust the position of bar 233 and locked it into place. A locking tab 940 is welded to bar 232, which has a hole through which a pad lock 941 (or similar locking mechanism) can be inserted and held in place over the paddle handle 932. Thus positioned, the pad lock 941 prevents the paddle handle 932 from opening unexpectedly during transit and causing the adjustable bar 233 to slip out of position.

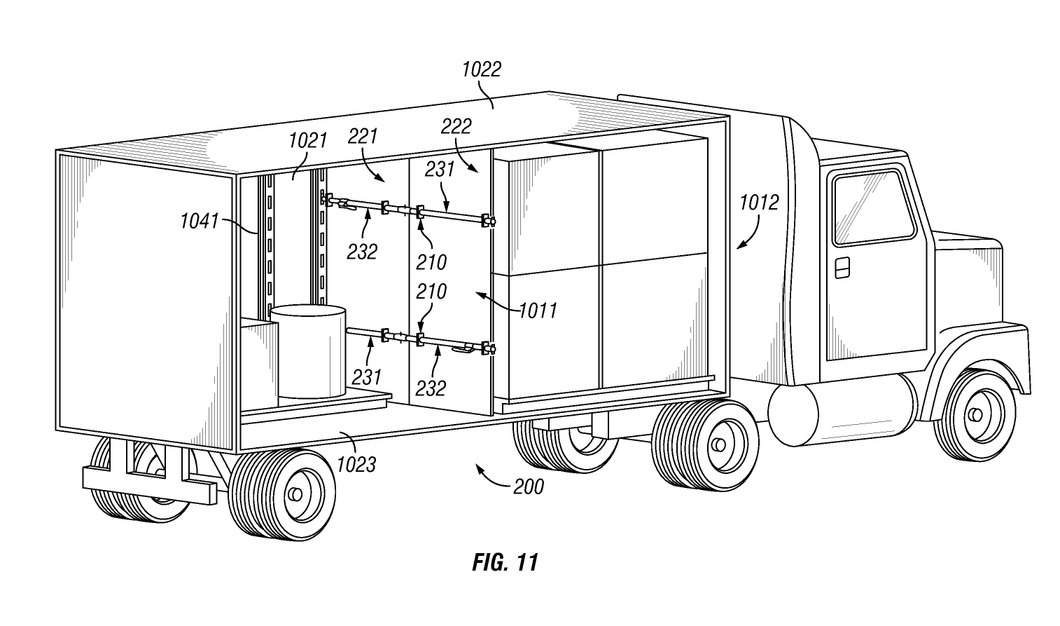

FIG. 11 shows an installed bulkhead in accordance with the present invention. After a compartment of the container is filled, the bulkhead panels 221, 222 are placed adjacent to one another to close off that section of the container, thereby dividing the container into a two compartments 1011 and 1012. Once in place, the bulkhead 200 spans the width of the container from one side 1021 to the other (not shown) and from the top of the container 1022 to the bottom 1023.

The cross bars 231, 232 are then fed through the angle brackets 210 and adjusted and locked into place. The cross bars are mounted to tracks 1041 along the walls 1021 of the container. The process is repeated depending on the number compartments into which the container will be divided.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated. It will be understood by one of ordinary skill in the art that numerous variations will be possible to the disclosed embodiments without going outside the scope of the invention as disclosed in the claims.

I claim:

1. A bulkhead assembly for dividing a cargo container into multiple compartments, the bulkhead comprising:
(a) at least one panel, wherein said at least one panel spans the width and height of said cargo container;
(b) at least one angle bracket mounted to said panel, wherein the angle bracket is bent at an approximately 90° angle thereby forming a base section and a perpendicular flanged arm, wherein the base section is mounted to the back face of the panel, and the flanged arm inserts through a slot in the panel and projects from the front face of the panel, and wherein the flanged arm has an opening; and
(c) at least one cross bar that slides through said opening in the flanged arm of the angle bracket in front of the panel and spans the width of the container to couple the bulkhead to the walls of the container, thereby securing the bulkhead in place.

2. The bulkhead assembly according to claim 1, further comprising tracks mounted along the walls of the container, wherein said cross bar can be coupled to multiple points along said track, thus allowing the position of the bulkhead to be adjusted along the length of the container.

3. The bulkhead assembly according to claim 1, further comprising two panels, wherein when said panels are placed adjacent to each other they span the width and height of the cargo container, and wherein each panel has at least one angle bracket coupled to it.

4. The bulkhead assembly according to claim 1, wherein the angle bracket further comprises a backing plate mounted on the front face of the panel, wherein said backing plate is coupled to the base section of the angle bracket by at least one bolt that passes through the backing plate, panel, and base section.

5. The bulkhead assembly according to claim 1, wherein the cross bar further comprises a first tubing section and a second tubing section, wherein the tubing sections are coupled together by partially sliding one tubing section into the other.

6. The bulkhead assembly according to claim 5, wherein the first tubing section and second tubing section are secured together by contact friction from a tack weld on at least one of the tubing sections.

7. The bulkhead assembly according to claim 5, wherein the cross bar further comprises:
a third tubing section at an end of the cross bar, wherein said third section is slidably disposed inside one of the other two tubing sections;
a rack gear coupled to said third tubing section;
a paddle handle coupled to the tubing section into which said third tubing section is slidably disposed, wherein said rack gear feeds through the paddle handle allowing the paddle handle to lock and release said rack gear in order to adjust the slidable position of the third tubing section and hold it in place; and
a locking tab coupled to the tubing section into which said third tubing section is slidably disposed, wherein the locking tab includes an opening through which a lock can be fed to mechanically hold the paddle handle in a closed position.

8. The bulkhead assembly according to claim 1, further comprising two or more cross bars coupled to the bulkhead at different heights.
